(19) United States
(12) Patent Application Publication
(10) Pub. No.: US 2024/0152713 A1
(43) Pub. Date: May 9, 2024

(54) RING SCANNER LANGUAGE (RISL) INTERPRETER

(71) Applicant: INFINITE PERIPHERALS, INC., Irvine, CA (US)

(72) Inventors: John BRODERICK, Corona, CA (US); Jeffrey SCOTT, Irvine, CA (US)

(73) Assignee: INFINITE PERIPHERALS, INC., Irvine, CA (US)

(21) Appl. No.: 18/386,774

(22) Filed: Nov. 3, 2023

Related U.S. Application Data
(60) Provisional application No. 63/422,206, filed on Nov. 3, 2022.

(51) Int. Cl. G06K 7/14

(52) U.S. Cl. CPC G06K 7/1413

(57) ABSTRACT

A custom designed programming language for a ring scanner is disclosed. The ring scanner language, also referred to as RISL, is uniquely designed to meet the requirements and needs of ring scanners. It is meant to be a light weight language that can be written through one or more commands to generate custom screens/interfaces/cards of the ring scanner.

### CROSS-REFERENCE TO RELATED APPLICATIONS

This application claims the benefit of U.S. Provisional Application 63/422,206, filed on Nov. 3, 2022, the contents of which is incorporated by reference herein in its entirety.

### BACKGROUND

### Field

The field is generally related to scanning devices.

### Related Art

Optical labels, such as barcodes, represent data in a visual, machine-readable format. One type of barcode, known as linear or one-dimensional (1D) barcodes, can represent data by varying the widths and spacing of parallel lines. Another type of barcode, known as matrix codes, two-dimensional (2D) barcodes, or QR codes, use rectangles, dots, hexagons and other patterns to represent data.

Barcodes have many applications. In stores, universal product code (UPC) barcodes are pre-printed on most items and are used for inventory and to check out. Barcodes are used in healthcare and hospital settings, for things like patient identification (to access patient data, including medical history, drug allergies, etc.). They can also be used to keep track of objects and people; they are used to keep track of rental cars, airline luggage, nuclear waste, registered mail, express mail and parcels. Barcoded tickets allow the holder to enter sports arenas, cinemas, theatres, fairgrounds, and transportation, and are used to record the arrival and departure of vehicles from rental facilities, etc.

A barcode reader (or barcode scanner) is an optical scanner that can read printed barcodes, decode the data contained in the barcode and send the data to a computer. One type of handheld scanner is gripped in a user's palm. With these handheld barcode scanners, the user encloses the handle with all five fingers and uses the trigger button to activate the scanner, like the operation of a handgun. One downside of handheld barcode scanners is that the user of the scanner has to put down the scanner to use his hand. If the user is transporting packages or taking inventory, having to repeatedly put down and pick up the scanner can result in lost productivity.

To reduce this inefficiency, ring scanners operate by looping around at least one finger, enabling an operator to continue using both hands while carrying the scanner. In this way, workers can continue to use both hands when climbing ladders or stairs, handling large items, or operating machinery.

Ring scanners must be programmed to perform their functions. One option for programming ring scanners is to use standard programming languages to code the various functions. The problem with standard programming languages is that they do not have built in methods and functions designed to accommodate the specialized functions performed by ring scanners. Therefore, it is desirable to have a custom programming language specifically designed for ring scanners.

### BRIEF SUMMARY

A non-transitory computer readable medium and ring scanner are disclosed, which store a custom programming language to enable operation of the ring scanner. The custom programming language, which will also be referred to as the Ring Scanner Language or RISL throughout this application, is designed specifically for use with ring scanners. Thus, RISL takes into account and is designed to accommodate the specialized form factor, display size, and functionality required of ring scanners. RISL provides a light weight language that is designed to take into account the memory constraints of a ring scanner. Thus, it is not memory intensive to store the language. It is also designed so that it can be easily written by non-technical persons. This is achieved because the language is designed as a set of commands that can be written in a simplified script type format, where each command can be written as a string. In aspects, the string can be formatted as:
[symbol][command name][delimiter][parameters], where,
   [symbol] can be a mark or character used as a conventional representation of an object, function, or process, and it can signal the beginning of a command,
   [command name] can be a string indicating a name of a command,
   [delimiter] can be a mark or character specifying a boundary between the [command name] and [parameters], and
   [parameters] can be an input value for defining an operation of the one or more commands.

In aspects, commands can be strung together a computer files, such as text files, which can be read by one or more computing devices of the ring scanner, and can be used as input to define screens of the ring scanner, or set the control functions of the ring scanner. In aspects, the commands can enable customization and setting of at least:
Screens that are displayed on a display of the ring scanner,
A screen width and screen height of custom screens of the ring scanner,
A font of custom screens of the ring scanner,
A text of the custom screens of the ring scanner,
Icons for the custom screens of the ring scanner, and
A color of the custom screens of the ring scanner.

In aspects, the commands can also enable at least:
Generating custom screens to be displayed on a display of the ring scanner,
Saving custom screens generated,
Loading custom screens of the ring scanner,
Searching for custom screens of the ring scanner,
Setting placeholders within a custom screen, where the placeholders can be populated with custom information in place of the placeholder at a later time,
Setting an audio output based on a triggering event of a custom screen,
Setting a haptic output based on a triggering event of a custom screen, and
Allowing deletion of custom screens of the ring scanner.

Other functions in addition to or in place of those mentioned above can be implemented by RISL. The functions will become apparent to those skilled in the art from a reading of the following detailed description when taken with reference to the accompanying drawings.

### BRIEF DESCRIPTION OF THE DRAWINGS

The accompanying drawings, which are incorporated herein and form part of the specification, illustrate the present disclosure and, together with the description, further serve to explain the principles of the disclosure and to enable a person skilled in the relevant art to make and use the disclosure.

FIGS. 1A and 1B are diagrams illustrating a ring scanner in operation, according to aspects.

FIGS. 2A and 2B are schematic diagrams illustrating the ring scanner in greater detail, according to aspects.

FIG. 3 is a cross section of the ring scanner, according to aspects.

FIG. 4 is an architecture diagram illustrating hardware components of the ring scanner, according to aspects.

FIG. 5 shows a system level diagram of where a ring scanner language (RISL) resides within the architecture of a ring scanner, according to aspects.

FIGS. 6A and 6B show custom screens/cards that can be generated using RISL, according to aspects.

FIG. 7 shows a dashboard that can be used by a programmer to interface with a ring scanner via a remote system (remote servers, computers, etc.), according to aspects.

The drawing in which an element first appears is typically indicated by the leftmost digit or digits in the corresponding reference number. In the drawings, like reference numbers may indicate identical or functionally similar elements. The drawings are illustrative and may not be to scale.

### DETAILED DESCRIPTION

### Ring Scanner Architecture

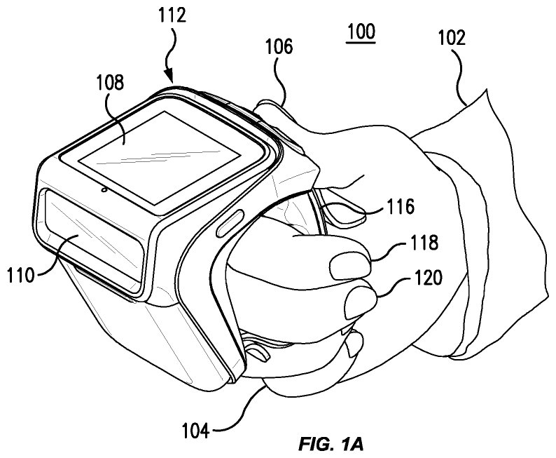

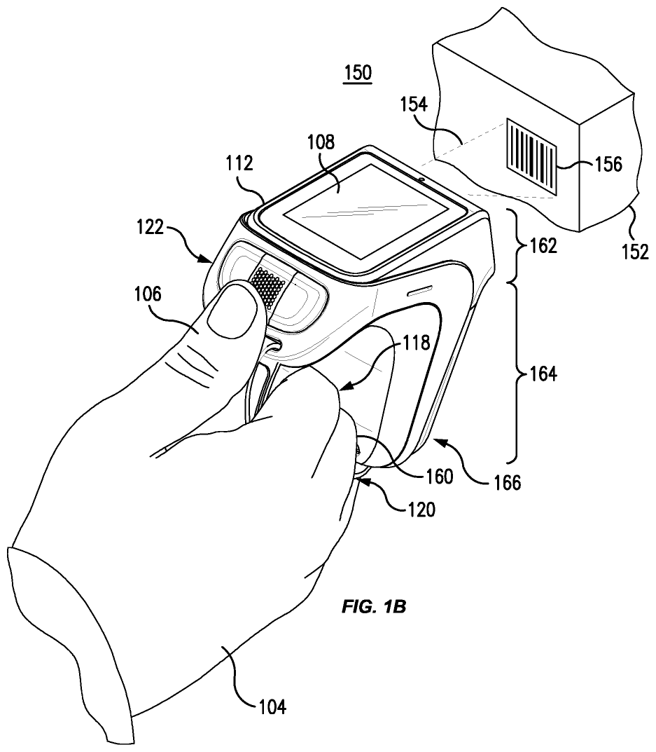

FIGS. 1A and 1B are diagrams illustrating a ring scanner in operation, according to aspects. FIG. 1A shows a diagram 100 with a user/operator having a hand 104 and forearm 102. Hand 104 is gripping a ring scanner 112. Ring scanner 112 has a display 108 and an optical scanner 110.

As may be seen in diagram 100, ring scanner 112 has a loop 116 through which an index finger 118 and a middle finger 120 pass through to grip and hold ring scanner 112. Loop 116 is configured to be gripped by index finger 118 and middle finger 120. It presses against the palmar side of index finger 118 and middle finger 120. Because loop 116 enables an operator to grip ring scanner 112 with just a loop around the operator's fingers, the operator maintains use of his or her hands. For example, the operator can continue to use his or her hands to operate equipment, carry packages, and climb ladders.

According to an aspect, loop 116 is configured to be gripped by index finger 118 and middle finger 120 such that the palm is in a neutral position when the optical detector is oriented in an upright direction. In this way, a user need not pronate the hand when transitioning from using the hand to grip a package from the package's side to scanning the optical label. The user's forearm 102 need not twist when scanning. Avoiding twisting in this way, the operator can avoid fatigue, discomfort, pain, and even possible injury.

Display 108 is an output device for presentation of information in visual form. It outputs information that is supplied to it from a computing device (not shown) in ring scanner 112 by converting electrical signals into light. In different aspects, display 108 may be an electroluminescent (ELD) display, liquid crystal display (LCD), light-emitting diode (LED) backlit LCD, thin-film transistor (TFT) LCD, light-emitting diode (LED) display, OLED display, AMOLED display, plasma (PDP) display, quantum dot (QLED) display, or electronic paper, such as E INK paper available from E Ink Corporation of Cambridge, Massachusetts.

Optical scanner 110 is an optical scanner that can read printed optical labels such as barcodes or can scan images of objects or take pictures of the objects, decode the data contained in the optical label, and send the data to a computer. It may include a light source, a lens, and a light sensor translating for optical impulses into electrical signals. In different aspects, optical scanner 110 may be a pen-type reader, a laser scanner, a charge-coupled device (CCD) reader, a light emitting diode (LED) scanner, a camera-based reader, a video camera reader, a large field-of-view reader, or an omnidirectional barcode scanner.

FIG. 1B shows a diagram 150 illustrating ring scanner 112 from a different perspective. As shown in diagram 100, ring scanner 112 is in this position to project light 154 to capture a barcode 156 on package 152.

As shown in diagram 150, barcode 156 is oriented in a horizontal direction, read left to right or right to left. Barcode 156 is a linear dimensional (1D), one dimensional barcode with its lines running vertical to ground. In other aspects, barcode 156 may be two-dimensional and use rectangles, dots, hexagons and other patterns. In other aspects, the package 152 itself may be scanned as an image/picture.

As shown in diagram 150, when positioned to capture barcode 156 in an upright direction the user's palm of hand 104 is oriented substantially vertically. The palm of hand 104 is orthogonal to the ground.

As shown in diagram 150, ring scanner 112 includes a body piece 166, which includes an upper body portion 162 and a lower body 164. Upper body portion 162 rests on a portion of index finger 118 facing a thumb 106 of hand 104. Lower body 164 covers a dorsal side of index finger 118 and middle finger 120 of hand 104. Upper body portion 162 and lower body 164 are affixed to one another and angled to cover at least a portion of the thumb-facing side of index finger 118 and the dorsal side of middle finger 120. Together with loop 116, upper body portion 162 and lower body portion 164 encircle index finger 118 and middle finger 120. More specifically, together with loop 116 (labeled in FIG. 1A), upper body portion 162 and lower body 164 may encircle a middle phalanx portion index finger 118 and middle finger 120.

Upper body portion 162 includes a plurality of buttons 122 that, when selected, causes ring scanner 112 to perform certain actions. Each of the plurality of buttons 122 may be a switch mechanism with a surface that may be depressed, or pushed, by a finger. When the surface is depressed, an electrical signal is sent to input information and possibly trigger an action. Each of the plurality of buttons 122 may have a spring to return to their un-pushed state. Other types of buttons may be used as well, such as virtual buttons presented on a touchscreen display.

As will be described below, the plurality of buttons 122 may cause optical scanner 110 to activate and scan barcode 156 or may input data into a computing device controlling aspects of ring scanner 112. The plurality of buttons 122 are positioned on ring scanner 112 to be selected by thumb 106.

In particular, buttons 122 are positioned to be selected by thumb 106 when hand 104 is gripping a ring scanner 112, and index finger 118 and middle finger 120 are bent. According to an aspect, buttons 122 are positioned to be selected when index finger 118 and middle finger 120 are bent at a proximal interphalangeal joint 160. Proximal interphalangeal joint 160 sits between a middle phalanx and proximal phalanx of index finger 118 and middle finger 120. Bending at proximal interphalangeal joint 160 may be more ergonomical than bending other joints, such as the metacarpophalangeal joint of index finger 118 and middle finger 120.

Display 108 may be a touchscreen display. A touchscreen display is an assembly of both an input (touch panel) and output (display) device. The touch panel may be layered on the top of the output electronic visual display. A user can give input, or can control a computing device (not shown) in ring scanner 112 through simple or multi-touch gestures by touching the screen with a special stylus or one or more fingers. In different examples, a touch panel may be a resistive touchscreen panel, a surface acoustic wave (SAW) touch panel, a capacitive touchscreen panel, or an infrared touchscreen panel.

When display 108 is a touchscreen display, display 108 will also be positioned such that at least a portion of display 108 may be selected by thumb 106 when hand 104 is gripping a ring scanner 112, and index finger 118 and middle finger 120 are bent at the proximal interphalangeal joint 160. Display 108 is configured to output visually from the computing device.

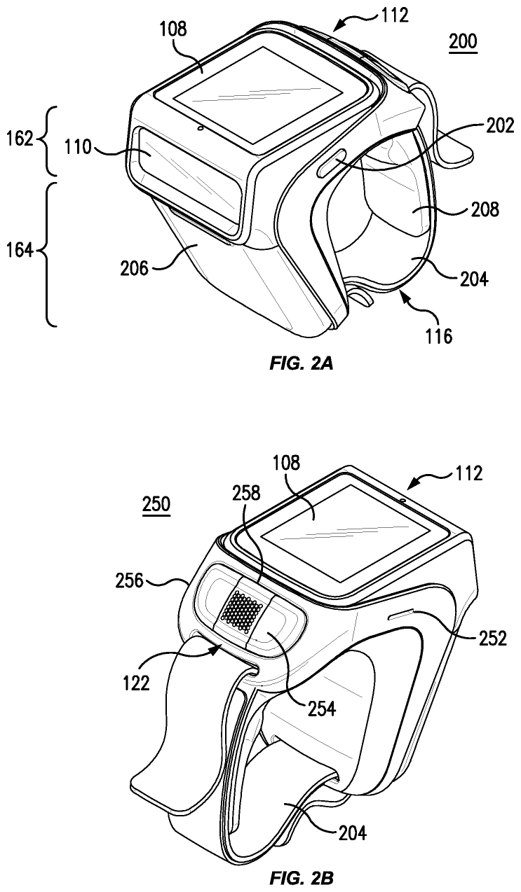

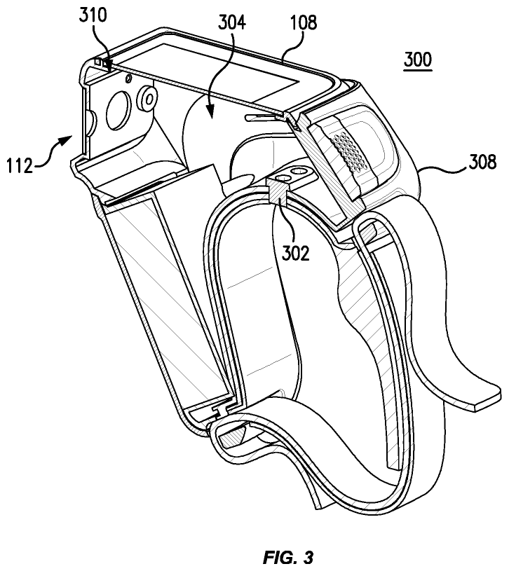

FIGS. 2A and 2B are schematic diagrams illustrating the ring scanner 112 in greater detail, according to aspects. FIG. 2A illustrates a front three-quarter view 200 of ring scanner 112. As shown from this perspective, ring scanner 112 includes a battery 206, power button 202, strap 204, and semi-rigid portion 208.

Battery 206 is a device including one or more electrochemical cells to provide power for ring scanner 112. In an example, battery 206 may be a lithium-ion battery. According to an aspect, battery 206 may be removable so that it may be swapped out with fully charged batteries when battery 206 is depleted. Additionally or alternatively, battery 206 could be internal to device 212 and not removable. Battery 206 may be rechargeable.

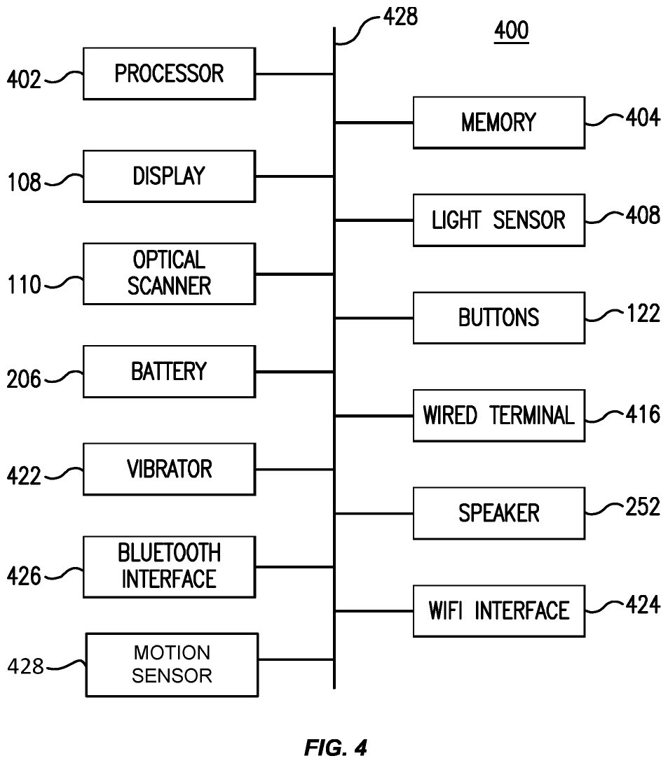

Power button 202 is a button that, when selected, causes ring scanner 112 to power on or off. When ring scanner 112 powers on, electricity is delivered from battery 206 to components of ring scanner 112, such as optical scanner 110, display 108, and other hardware components as will be discussed in greater detail with respect to FIG. 4.

Strap 204 is a ribbon used to fasten ring scanner 112 to the operator's fingers. As described above, strap 204, in conjunction with other components of ring scanner 112 may encircle an operator's fingers. Strap 204 may be made of nylon webbing, leather or other flexible materials. It also may be an adjustable strap positioned to encircle the at least one finger.

Semi-rigid portion 208 protrudes from upper portion 162 and is situated behind strap 204, in particular between strap 204 and the operator's fingers (not shown). Semi-rigid portion 208 may be flexible such that, as strap 204 is tightened, the tightened strap may pull semi-rigid portion 208 to tighten on the operator's fingers. Semi-rigid portion 208 may serve to allow strap 204 to be tightened, enabling the operator to maintain a tight grip on ring scanner 112 without irritating the operator's fingers. In an aspect, semi-rigid portion 208 may be made of rubber or a rubber-like material. In illustrative examples, semi-rigid portion 208 may be made of Thermoplastic Polyurethane (TPU), Thermoplastic Elastomer (TPE), butyl (IIR), nitrile (NBR), Neoprene® (CR), Ethylene Propylene Diene Monomer (EPDM), Silicone (Q), or Viton®.

FIG. 2B illustrates a rear three-quarter view 250 of ring scanner 112. As may be seen from this perspective, ring scanner 112 includes a speaker 252 and plurality of buttons 122.

Speaker 252 is a device which converts an electrical audio signal into a corresponding audible sound. Example speakers include moving-iron loudspeakers, piezoelectric speakers, magnetostatic loudspeakers, electrostatic loudspeakers, ribbon and planar magnetic loudspeakers, bending wave loudspeakers, flat panel loudspeakers, Heil air motion transducers, transparent ionic conduction speakers, plasma arc speakers, thermoacoustic speakers, rotary woofers, moving-coil, electrostatic, electret, planar magnetic, and balanced armature. The speaker 252 can also include a microphone integrated therewith to receive audio inputs.

As illustrated in FIG. 2B, buttons 122 includes three buttons: left button 256, right button 254, and center button 258. Left and right buttons (256 and 254) may input selections into a computing device (not shown) in ring scanner 112. This may cause an action to be specified by an application executed by the computing device. In one example, the application may display a menu on display 108 and selecting buttons 254 and 256 may enable a user to navigate through lists or menus. In this way, aspects enable interactive applications to be executed by the ring scanner 112.

Center button 258 is configured to, when selected, activate optical scanner 110 to read a barcode or scan an image. It also may send input data to the computing device of the ring scanner 112.

Left button 256, right button 254, and center button 258 can also be used in a communication mode of the ring scanner 112. For example, selecting each of these buttons can provide a different functionality when the ring scanner 112 is in the communication mode. The functionality can include, for example, enabling/disabling a telephone call, enabling recording of a voice message, skipping forward and backward through voice messages, etc.

FIG. 3 is a cross section of the ring scanner 112, according to aspects. Housing 308 is a protective exterior (e.g., shell) or an enclosing structural element (e.g., chassis or exoskeleton) designed to enable easier handling, provide attachment points for internal mechanisms (e.g., mounting brackets for electrical components, cables, and pipings), maintain cleanliness of the contents by shielding dirt/dust, fouling and other contaminations, or protect interior mechanisms (e.g., delicate integrated electrical fittings) from structural stress and/or potential physical damage.

The interior of housing 308 includes a cavity 304 that contains various electronic components, as illustrated in FIG. 4. Housing 308 includes an opening 310, display 108, and other openings, such as an opening for a charging port 302 when charging the battery 206.

Charging port 302 is configured to electrically couple ring scanner 112 to a cradle, and positioned directed toward the loop 116. Charging port 302 may be a USB port as discussed with respect to FIG. 4 below. Ring scanner 112 may include at least one magnet (not shown) positioned to align the charging port to the cradle to enable electrical coupling.

Alternatively or additionally, ring scanner 112 may be capable of wireless charging. For example, ring scanner 112 may have a silicon chip that receives a beacon signal to charge the device. For example, the chip may enable a power transmitter to locate a device and transmit power directly to the device, along the path used to detect the chip. This path based functionality may allow the wireless power transmitter to continuously and safely send power when needed. In examples, ring scanner 112 may use the COTA power transmitter/receiver available from Ossia Inc. of Bellevue, WA or the WattUp power transmitter/receiver available from Energous Corporation.

FIG. 4 is an architecture diagram 400 illustrating hardware components of the ring scanner 112, according to aspects. As discussed with respect to previous figures, diagram 400 includes display 108, optical scanner 110, buttons 122, battery 206, and speaker 252. In addition to those components, diagram 400 includes a processor 402, memory 404, light sensor 408, wired terminal 416, vibrator 422, Bluetooth interface 426, Wi-Fi interface 424, and a motion sensor 428. Each of these components of FIG. 4 is enclosed within housing 308 shown in FIG. 3.

Bus 428 is a communication system that transfers data between the hardware components of a ring scanner 112. In addition to transferring data, bus 428 may also transfer electrical power, such as from battery 206 to other components. In this way, bus 428 communicatively and electrically couples the various components.

It may be appreciated for those skilled in the art that a plurality of signal lines or buses may exist, thus different components may be linked by different signal lines or buses, and that a signal line or bus depicted in the schematic diagram may represent a plurality of such.

Memory 404 may include random access memory (RAM) and may also include nonvolatile memory, such as read only memory (ROM) and/or flash memory. Memory 404 may be embodied as an independent memory component, and may also be embedded in another component, such as processor 402, or may be embodied as a combination of independent as well as embedded, and/or a plurality of memory components. Memory 404 is adapted to include software modules (a module is a set of instructions) or RISL.

Processor 402 is adapted to run instructions stored in memory 404. Processor 402 may be a micro-controller unit (MCU), a digital signal processor (DSP) and/or an Image/Video Processing unit or the like components that run instructions. An example of an MCU is MSP432P401x, available from Texas Instruments Inc. of Dallas, Texas. An example of a DSP is C5000, available from Texas Instruments Inc. An example of an image/video processor is OMAP3525, available from Texas Instruments Inc. One or more processors may be present. Processor 402 may be an independent component; it may also be embedded in another component, such as in light sensor/camera 408, or any combination thereof.

Wired terminal 416 is adapted to attach to a wired network, including, but not limited to, Ethernet, USB, or thunderbolt.

Diagram 400 includes two wireless interfaces, Wi-Fi interface 424 and Bluetooth interface 426. Wi-Fi interface 424 may provide a network interface accessible by applications running on processor 402. Bluetooth interface 426 may be adapted to enable the ring scanner 112 to interact with peripheral devices, such as headsets (not shown).

Light sensor 408 is a photodetector. It is a sensor of light. A photo detector has a p-n junction that converts light photons into current. The absorbed photons make electron—hole pairs in the depletion region. Photodiodes and phototransistors are a few examples of photo detectors. In a different example, light sensor 408 may be a photoemission or photoelectric effect photodetector, thermal photodetectors, polarization photodetectors, or photochemical photodetectors. Light sensor 408 may be integrated into a camera of the ring scanner 112.

In an example operation, light sensor 408 may signal to processor 402 when light is detected. Processor 402, in turn, may adjust the brightness of display 108 automatically. Adjusting brightness in this way may have the effect of conserving power in battery 206.

Vibrator 422 is a device that causes vibration when receiving a specified signal from processor 402. Vibrator 422 is a mechanical device to generate vibrations or haptic feedback. To generate the vibrations, vibrator 422 may include an electric motor with an unbalanced mass on its driveshaft. Vibrator 422 may be a vibrating structure gyroscope implemented as a microelectromechanical system (MEMS).

Speaker 252 is coupled to processor 402 and is configured to cause the ring scanner 112 to emit sound as specified by commands from processor 402. In this way, speaker 252 may provide audio to a user of the ring scanner 112 as specified by an application executed on processor 402. In aspects, a microphone can be integrated with the speaker 252 to allow the speaker 252 to also receive audio inputs. For example, speaker 252 can function to receive audio inputs to allow the ring scanner 112 to operate as a walkie-talkie or as a telephone. For example, in aspects the Wi-Fi interface 424 and/or Bluetooth interface 426 can couple to the speaker 252 and can allow the ring scanner 112 to operate as a phone or walkie-talkie using voice over IP (VoIP) technologies, or may be integrated into cellular/telephony circuitry installed on the ring scanner 112 to allow the ring scanner 112 to integrate telephone operations and capabilities.

The buttons 122 may send commands to the processor 402, or other components such as optical scanner 110. When a user presses one of the buttons 122, a signal may be sent to processor 402. That signal may cause an interrupt command in the software application executed by processor 402, causing processor 402 to run specific commands that an application specifies to correspond to that button input. In this way, using buttons 122, a user can trigger actions as specified by the application executed by processor 402.

In response to inputs it receives from buttons 122, processor 402 can output information to display 108 as specified by a software application executed by processor 402. In addition, as mentioned above, display 108 may be a touchscreen display. In this way, interactive applications may be implemented within the ring scanner 112.

In addition, not shown, other input devices may be included, such as a radiofrequency identification (RFID) reader and a near field communication (NFC) reader. RFID uses electromagnetic fields to automatically identify and track tags attached to objects. An RFID system consists of a tiny radio transponder, a radio receiver and transmitter. When triggered by an electromagnetic interrogation pulse from RFID reader, an RFID tag transmits digital data back to the reader. A NFC reader may allow for collection of payment data from an EMV chip or from a user's mobile device (not shown).

In examples, these NFC and RFID readers may be used for login purposes. An operator can swipe her badge in the vicinity of a ring scanner 112 having these features and the ring scanner 112 can log her in using the information received from the NFC chip or the badge. Then, when the operator is using the ring scanner 112, any scanned items are tracked with an identification of the operator who logged into the ring scanner 112.

Motion sensor 428 may be part of a circuitry or a standalone component that can detect the orientation of the ring scanner 112. For example, the motion sensor 428 may be an accelerometer, gyroscope, or a combination thereof that can by itself, or as part of an integrated circuit, determine the orientation of the ring scanner 112 in a three-dimensional space. For example, in aspects, the motion sensor 428 can detect an inclination angle of the ring scanner 112 to measure the orientation of the ring scanner 112 with respect to the ground. The inclination angle refers to the angle between the front plane that the optical scanner 110 is facing and the X-axis, where the X axis is parallel to the ground. In aspects, the detection of the inclination angle and determining what the angle is can allow the ring scanner to set an operating mode.

### The Ring Scanner Language (RISL)

In order to operate, the ring scanner 112 needs to be programmed. What is disclosed is a custom programming language for the ring scanner 112. The custom programming language, RISL, is designed specifically for use with scanners, especially ring scanners. Thus, RISL takes into account and is designed to accommodate the specialized form factor, display size, and functionality required of the ring scanner 112. RISL provides a light weight language that is designed to take into account the memory constraints of ring scanner 112. Thus, it is not memory intensive to store the language. It is also designed so that it can be easily written by non-technical persons. This is achieved because the language is designed as a set of commands that can be written in a simplified script format, where each command can be written as a string. In aspects, the string can be formatted as:
[symbol][command name][delimiter][parameters], where,
[symbol] can be a mark or character used as a conventional representation of an object, function, or process, and it can signal the beginning of a command,
[command name] can be a string indicating a name of a command,
[delimiter] can be a mark or character specifying a boundary between the [command name] and [parameters], and
[parameters] can be an input value for defining an operation of the one or more commands. the [parameters] can be added sequentially and separated by a [delimiter] if the command takes more than one [parameters].

In aspects, [symbol] can be any symbol or character, such as an accent mark, a circumflex accent, a forward slash, a backwards slash, a hyphen, etc. In aspects, [command name] can be any character string specifying a command name. The specific commands and command names will be discussed further below. In aspects, [delimiter] can also be any symbol or character, different from [symbol], so as to not cause overlap or confusion of how it is interpreted by the computing devices of the ring scanner 112. In aspects, the [delimiter] can be used to signify the boundary between the [command name] and [parameters], and can indicate that the values that come after the [delimiter] are values, parameters, or variables of the commands, if the command has input parameters that define it.

In aspects, commands can be strung together a computer files, such as text files, which can be read and processed by one or more computing devices (e.g., processor 402) of the ring scanner 112, and can be used to define screens of the ring scanner 112, or set the control functions of the ring scanner 112. In aspects, the commands can enable customization and setting of at least:
Screens that are displayed on a display (e.g., display 108) of the ring scanner 112,
A screen width and screen height of custom screens of the ring scanner 112,
A font of custom screens of the ring scanner 112,
A text of the custom screens of the ring scanner 112,
Icons/buttons for the custom screens of the ring scanner 112, and
A color of the custom screens of the ring scanner 112.

In aspects, the commands can also enable at least:
Generating custom screens to be displayed on a display (e.g., display 108) of the ring scanner 112,
Saving custom screens generated,
Loading custom screens of the ring scanner 112,
Searching for custom screens of the ring scanner 112,
Setting placeholders within a custom screen, where the placeholders can be populated with custom information in place of the placeholder at a later time,
Setting an audio output based on a triggering event of a custom screen,
Setting a haptic output based on a triggering event of a custom screen, and
Allowing deletion of custom screens of the ring scanner 112.

The various commands of RISL will be described in more detail in Table 1 below. Table 1 is not meant to be limiting, but describes the current set of commands of RISL. A person of ordinary skill in the art will recognize that as functionality evolves for ring scanners, commands can be added to the list. Thus, the list of commands is meant to serve as a baseline for RISL based on the current state of ring scanner 112 technology.

The commands in Table 1 will be described by giving the name of the command, a description of the command, and describing how the command is used in conjunction with other commands. The format column describes how the command is called. The parameters column describes what parameters the command takes. In the table below it is assumed that the [symbol] is a circumflex accent represented by “A”. It is also assumed that the [delimiter] is a vertical line represented by “1”.

TABLE 1

| Command Name | Description | Format | Parameters |
|---|---|---|---|
| \hat{ }StartCard | The \hat{ }StartCard | \hat{ }StartCard\| width \| height | Width: The width |
| | command starts/loads | | parameter is the card |
| | a new custom screen | | width (in pixels). The |
| | using the size | | value can be in the |
| | parameters supplied. | | range of 1 to 290, |
| | The custom screen can | | where 290 is the |
| | also be referred to as a | | maximum width of the |
| | “card.” Any | | card in pixels. |
| | commands send after a | | Height: The height |
| | card is started will | | parameter is the card |
| | apply to the card. Only | | height (in pixels). The |
| | after other commands | | value can be in the |
| | of \hat{ }ShowCard or | | range of 1 to 200, |
| | \hat{ }SaveCard are called | | where 200 is the |
| | will the card be ended. | | maximum height of |
| | When a card has | | the card in pixels. |
| | ended any commands | | |
| | that are received will | | |
| | be ignored until a new | | |
| | card is started using | | |
| | another \hat{ }StartCard | | |
| | command. | | |
| \hat{ }Font | The \hat{ }Font command | \hat{ }Font\|size\|attribute\|attribute | Size: The font size can |
| | sets the current font | | be any integer. |
| | that any Text (\hat{ }Text, | | Attribute: The |
| | \hat{ }TextC, \hat{ }TextL, | | attribute can be any of |
| | \hat{ }TextR) or Button | | the following: bold, |
| | (\hat{ }Button) command | | underline, italic, and a |
| | will adhere to. The | | hex color with the |
| | command can take a | | format #FFFFFF. |
| | list of attributes that | | |
| | will be applied to the | | |
| | current font. The | | |
| | current font can be set | | |
| | multiple times in a | | |
| | single card allowing | | |
| | for text and buttons to | | |
| | use different fonts at | | |
| | once. For example, the | | |
| | command | | |
| | \hat{ }Font\|24\|Bold\|Underline\| | | |
| | #FFFFFF would set | | |
| | the current font to be | | |
| | size 24, Bold and | | |
| | Underlined with a | | |
| | white hex color | | |
| | (#FFFFFF). Any | | |
| | \hat{ }Text command that | | |
| | follows would use this | | |
| | font when writing to | | |
| | the current card. In | | |
| | addition, any \hat{ }Button | | |
| | that had text would | | |
| | use this font as well. | | |
| \hat{ }Text | The \hat{ }Text command | \hat{ }Text\|x\|y\|text | X: The x parameter |
| | writes text at a given | | represents the x |
| | x,y coordinate. The | | coordinate (in pixels). |
| | text will be written | | The value can range |
| | using whatever the | | from 1 to 290 where |
| | current font is set to. If | | 290 is the maximum |
| | no font was set before | | width of the card. |
| | the \hat{ }Text command, | | Y: The y parameter |
| | then the default font | | represents the y |
| | will be used. The | | coordinate (in pixels). |
| | default font is size 24 | | The value can range |
| | in white. | | from 1 to 200 where |
| | | | 200 is the maximum |
| | | | height of the card. |
| | | | Text: The text |
| | | | parameter can be any |
| | | | string that is to be |
| | | | shown on the card. |
| \hat{ }TextC | The \hat{ }TextC | \hat{ }TextC\|y\|text | Y: The y parameter |
| | command writes | | represents the y |
| | centered text at any | | coordinate (in pixels). |
| | given y pixel row. The | | The value can range |
| | text will be written | | from 1 to 200 where |
| | using whatever the | | 200 is the maximum |
| | current font is set to. If | | height of the card. |
| | no font was set before | | Text: The text |
| | the \hat{ }TextC command, | | parameter can be any |
| | then the default font | | string that is to be |
| | will be used. The | | shown on the card. |
| | default font is size 24 | | |
| | in white. | | |
| \hat{ }TextL | The \hat{ }TextL command | \hat{ }TextL\|y\|text | Y: The y parameter |
| | writes left justified | | represents the y |
| | text at any given y | | coordinate (in pixels). |
| | pixel row. The text | | The value can range |
| | will be written using | | from 1 to 200 where |
| | whatever the current | | 200 is the maximum |
| | font is set to. If no font | | height of the card. |
| | was set before the | | Text: The text |
| | \hat{ }TextL command, | | parameter can be any |
| | then the default font | | string that is to be |
| | will be used. The | | shown on the card. |
| | default font is size 24 | | |
| | in white. | | |
| \hat{ }TextR | The \hat{ }TextR | \hat{ }TextR\|y\|text | Y: The y parameter |
| | command writes right | | represents the y |
| | justified text at any | | coordinate (in pixels). |
| | given y pixel row. The | | The value can range |
| | text will be written | | from 1 to 200 where |
| | using whatever the | | 200 is the maximum |
| | current font is set to. If | | height of the card. |
| | no font was set before | | Text: The text |
| | the \hat{ }TextR command, | | parameter can be any |
| | then the default font | | string that is to be |
| | will be used. The | | shown on the card. |
| | default font is size 24 | | |
| | in white. | | |
| \hat{ }Button | The \hat{ }Button | \hat{ }Button\|x\|y\|width\|height\|color\|text\|id | X: The x parameter |
| | command creates a | | represents the x |
| | button at a given x,y | | coordinate (in pixels). |
| | coordinate. The | | The value can range |
| | command takes in | | from 1 to 290 where |
| | parameters that define | | 290 is the maximum |
| | size, title, and color. | | width of the card. |
| | The button title will | | Y: The y parameter |
| | use the current font | | represents the y |
| | that is set. | | coordinate (in pixels). |
| | | | The value can range |
| | | | from 1 to 200 where |
| | | | 200 is the maximum |
| | | | height of the card. |
| | | | Width: The width is |
| | | | the width of the |
| | | | button. The values can |
| | | | range from 1 to 290, |
| | | | where 290 is the |
| | | | maximum width of the |
| | | | button. |
| | | | Height: The height is |
| | | | the height of the |
| | | | button. The values can |
| | | | range from 1 to 200, |
| | | | where 200 is the |
| | | | maximum height of |
| | | | the button. |
| | | | Color: The color is |
| | | | the background color |
| | | | of the button. The |
| | | | color can be set using |
| | | | hex format #FFFFFF. |
| | | | Text: The text |
| | | | parameter can be any |
| | | | string that is to be |
| | | | shown on the button. |
| | | | Id: The id parameter |
| | | | indicates the identifier |
| | | | returned when the |
| | | | button is pressed on a |
| | | | card. The identifier |
| | | | can be set to be any |
| | | | string. |
| \hat{ }CardBackColor | The | \hat{ }CardBackColor\|color | Color: The color is |
| | \hat{ }CardBackColor | | the background color |
| | command sets the | | of the card. The color |
| | backfround color of | | can be set using hex |
| | the current card using | | format #FFFFFF. |
| | the given color. | | |
| \hat{ }ShowCard | The \hat{ }ShowCard | \hat{ }ShowCard | N/A |
| | command will display | | |
| | the current card to the | | |
| | ring scanner 112 | | |
| | display 108. After this | | |
| | is done, the current | | |
| | card has effectively | | |
| | “ended”. This means a | | |
| | new card must be | | |
| | “started” using the | | |
| | \hat{ }StartCard or | | |
| | \hat{ }LoadCard | | |
| | commands before you | | |
| | can start adding other | | |
| | RISL commands. Any | | |
| | commds received | | |
| | before a new card is | | |
| | “started” are ignored. | | |
| \hat{ }SaveCard | The \hat{ }SaveCard | \hat{ }SaveCard\|name | Name: The name is |
| | command is a | | the name of the card |
| | convenience command | | given. It can take the |
| | that allows a RISL | | value of any string to |
| | card to be saved into | | uniquely identify the |
| | the ring scanner 112 | | card. |
| | memory 404, so it | | |
| | does not have to be | | |
| | written again once it is | | |
| | generated/created. | | |
| | This command is used | | |
| | in conjunction with | | |
| | the \hat{ }LoadCard | | |
| | command that loads a | | |
| | saved card to be the | | |
| | current card. | | |
| | \hat{ }SaveCard is similar | | |
| | to \hat{ }ShowCard in that | | |
| | when performed, the | | |
| | current card has | | |
| | effectively “ended” | | |
| | This means a new card | | |
| | must be “started” | | |
| | using the \hat{ }StartCard | | |
| | or \hat{ }LoadCard | | |
| | commands before | | |
| | other RISL commands | | |
| | can be added. Any | | |
| | commands received | | |
| | before a new card is | | |
| | “started” are ignored. | | |
| | Cards saved into the | | |
| | ring scanner 112 | | |
| | memory 404 will last | | |
| | until they are replaced | | |
| | or deleted. To replace | | |
| | a previously saved | | |
| | card, you can use the | | |
| | same previously saved | | |
| | card name and call | | |
| | \hat{ }SaveCard again. | | |
| \hat{ }LoadCard | The \hat{ }LoadCard | \hat{ }LoadCard\|name | Name: The name is |
| | command is used to | | the name of the card to |
| | load a previously | | be loaded. The value |
| | saved card from the | | can be any string that |
| | ring scanner 112 | | uniquely identifies the |
| | memory 404, and set it | | card. |
| | as the new current | | |
| | card. If no card | | |
| | matching the name is | | |
| | found, the ring | | |
| | scanner 112 will do | | |
| | nothing. If all the | | |
| | commands that make | | |
| | up a card before it is | | |
| | saved are loaded, the | | |
| | \hat{ }LoadCard | | |
| | command will load | | |
| | every one of those | | |
| | commands when it is | | |
| | called. | | |
| \hat{ }CardExists | The \hat{ }CardExists | \hat{ }CardExists\|name | Name: The name is |
| | command allows the | | the name of the card to |
| | server to check if a | | be checked. The value |
| | card matching the | | can be any string that |
| | provided name has | | uniquely identifies the |
| | been saved into the | | card. |
| | ring scanner 112 | | |
| | memory 404. This is | | |
| | useful when new ring | | |
| | scanners are | | |
| | introduced that might | | |
| | not have saved | | |
| | premade cards. | | |
| \hat{ }Set | The \hat{ }Set command | \hat{ }Set\|[placeholder]\|text | [Placeholder]: The |
| | leverages | | [placeholder] is the |
| | placeholders, which | | name of the |
| | can be added to any | | placeholder. The value |
| | text or button | | can be any string. The |
| | command. A | | placeholder must |
| | placeholder is any | | follow the format: |
| | string surrounded by | | [string]. |
| | square brackets. For | | Text: The text is the |
| | example, | | text that will replace |
| | [packageNum] can be | | the placeholder. The |
| | a placeholder. As the | | value can be any |
| | name suggests, a | | string. |
| | placeholder is meant | | |
| | to be replaced by a | | |
| | different string by | | |
| | using the \hat{ }Set | | |
| | command. If no string | | |
| | is set, the text or | | |
| | button will simply | | |
| | print the placeholder | | |
| | as is. This ability | | |
| | when used in | | |
| | conjunction with the | | |
| | \hat{ }SaveCard and | | |
| | \hat{ }LoadCard | | |
| | commands means you | | |
| | have the ability to | | |
| | change text in | | |
| | previously saved | | |
| | cards. | | |
| \hat{ }Vibrate | The \hat{ }Vibrate | \hat{ }Vibrate\|type | Type: The type is the |
| | command is used to | | type of vibration that |
| | vibrate the ring | | is to occur. The value |
| | scanner 112 to give | | can be an integer from |
| | the user haptic | | 1-4, which represent |
| | feedback. Calling the | | four different |
| | \hat{ }Vibrate command | | vibration lengths, with |
| | will result in the | | 1 being the shortest |
| | vibrator 422 to | | length and 4 being the |
| | vibrate. This | | longest length. The |
| | command is unique in | | lengths (in seconds or |
| | that it does not need to | | milliseconds) can be |
| | be included with a | | set by a designer of |
| | card to work and can | | the system. |
| | be used standalone. If | | |
| | it is included in a card, | | |
| | the device will vibrate | | |
| | when the current card | | |
| | is displayed with the | | |
| | \hat{ }ShowCard | | |
| | command. | | |
| \hat{ }PlaySound | The \hat{ }PlaySound | \hat{ }PlaySound\|type | Type: The type |
| | command is used to | | represents the type of |
| | play sounds from the | | sound. The value of |
| | ring scanner 112 to | | type can be a one of: |
| | give the user audio | | Good, Good2, Bad, |
| | feedback. The audio | | and Alert. Each of |
| | feedback can be given | | these will have a pre- |
| | via the speaker 252. | | defined sound |
| | The command is | | associated with it as |
| | unique in that it does | | set by a designer of |
| | not need to be | | the system. |
| | included with a card to | | |
| | work and can be used | | |
| | standalone. If it is | | |
| | include din a card, the | | |
| | sound will play when | | |
| | the current card is | | |
| | displayed with the | | |
| | \hat{ }ShowCard | | |
| | command. | | |
| \hat{ }Clear | The \hat{ }Clear command | \hat{ }Clear | N/A |
| | will erase all previous | | |
| | cards to give the user a | | |
| | new empty list. As | | |
| | RISL cards are sent to | | |
| | the ring scanner 112 | | |
| | memory 404, they are | | |
| | added to the end of a | | |
| | list of all cards | | |
| | received. The list | | |
| | allows the user to | | |
| | scroll up to see | | |
| | previous cards they | | |
| | received in case they | | |
| | need to view the | | |
| | information again. | | |

In aspects, the commands can be used in conjunction with an application that can act as the graphical user interface (GUI) for the ring scanner 112. The GUI has been described in U.S. application Ser. No. ______, filed on Nov. 3, 2023, the contents of which is incorporated by reference herein in its entirety. The application can utilize RISL to generate the custom screens/cards of the ring scanner 112 and to set the functionality of each of the custom screens/cards described in the aforementioned application.

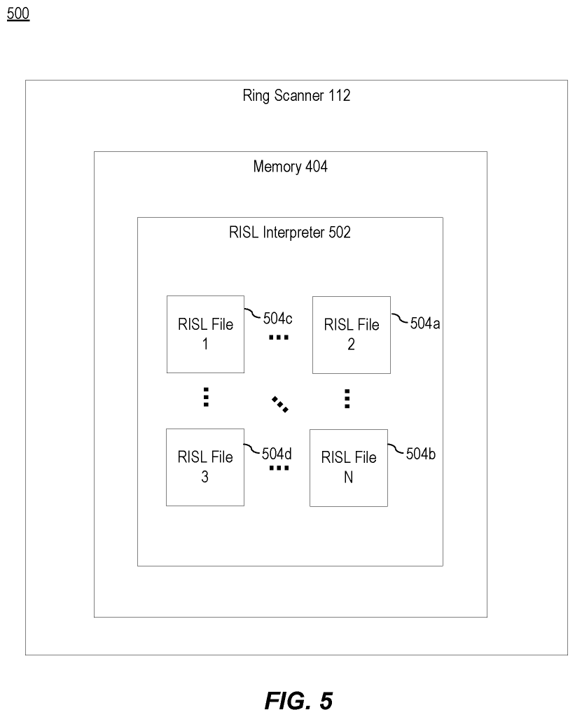

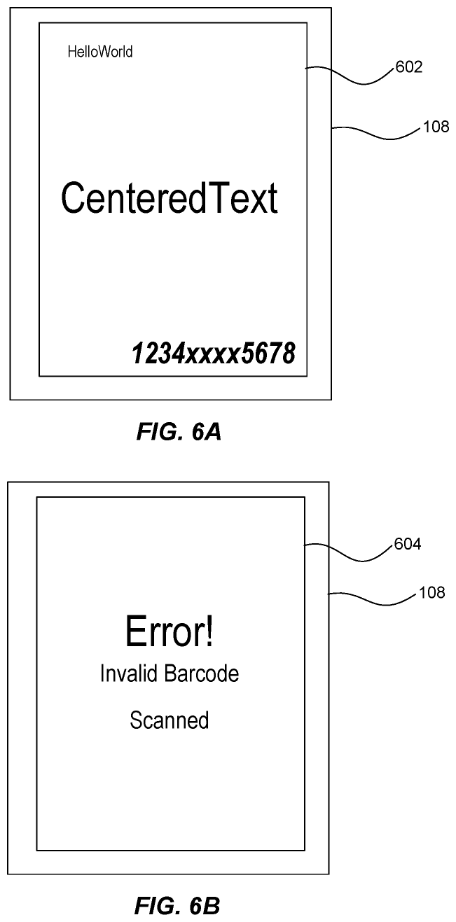

FIG. 5 shows a system level diagram 500 of where RISL resides within the architecture of the ring scanner 112, according to aspects. In aspects, RISL can be written into computer-readable files, such as text files, by a programmer of the ring scanner 112. In FIG. 5, the files are shown as {504a, 504b, 504c, 504d}. In aspects, there can be a number of RISL files each with its own set of commands that can be processed by the computing devices (e.g., the processor 402 of the ring scanner 112). When processed, RISL files can be compiled by a RISL interpreter 502, which is similar to a compiler but designed to interpret RISL into machine understandable byte code, that can translate the commands into machine understandable code that the ring scanner 112 can then use to carry out the commands written (such as to generate the various custom cards that are displayed on the display 108 of the ring scanner 112). FIGS. 6A and 6B show custom cards that can be generated using RISL. FIG. 6A shows a custom card 602 showing three different text commands. The custom card 602 can be displayed on display 108. The card shown in FIG. 6A can be generated using RISL commands shown in command set (1):

\hat{ }StartCard|290|180\hat{ }TextL|10|HelloWorld|\hat{ }Font|32|Bold #FF0000\hat{ }TextC|70|CenteredText\hat{ }Font|22|Italic|Bold|#00FF00\hat{ }TextR|140|1234xxxx5678\hat{ }Show Card (1)

Command set (1) creates card 602 with three different text commands. The first one occurs before any font is defined so it uses the default font. It is indicated by the text “HelloWorld,” which is shown as left justified with font size 10. After the first text command, a red and bold font is defined, which is applied to the text “CenteredText,” and is centered. Finally, a new font and text are defined that is right justified, bold and italic, and is applied to the text “1234xxx5678.”

FIG. 6B shows a custom card 604. Card 604 can be displayed on display 108. The card shown in FIG. 6B can be generated using RISL commands shown in command set (2):

\hat{ }StartCard|290|160\hat{ }CardBackColor|#FF0000\hat{ }Font|48|Bold|#FFFFFFATextC |4|Error!\hat{ }Font|28|Bold|#FFFFFF\hat{ }TextC|80|Invalid Barcode Scanned\hat{ }Vibrate|2\hat{ }PlaySound|Bad\hat{ }ShowCard (2)

In FIG. 6B, the background of card 604 is set to a bright red to get the user's attention while making sure the font is size 48 and bold. Card 604 also sets a vibration and a sound to be played when card 604 is displayed. The vibration is set to “2” and the sound is set to “Bad.”

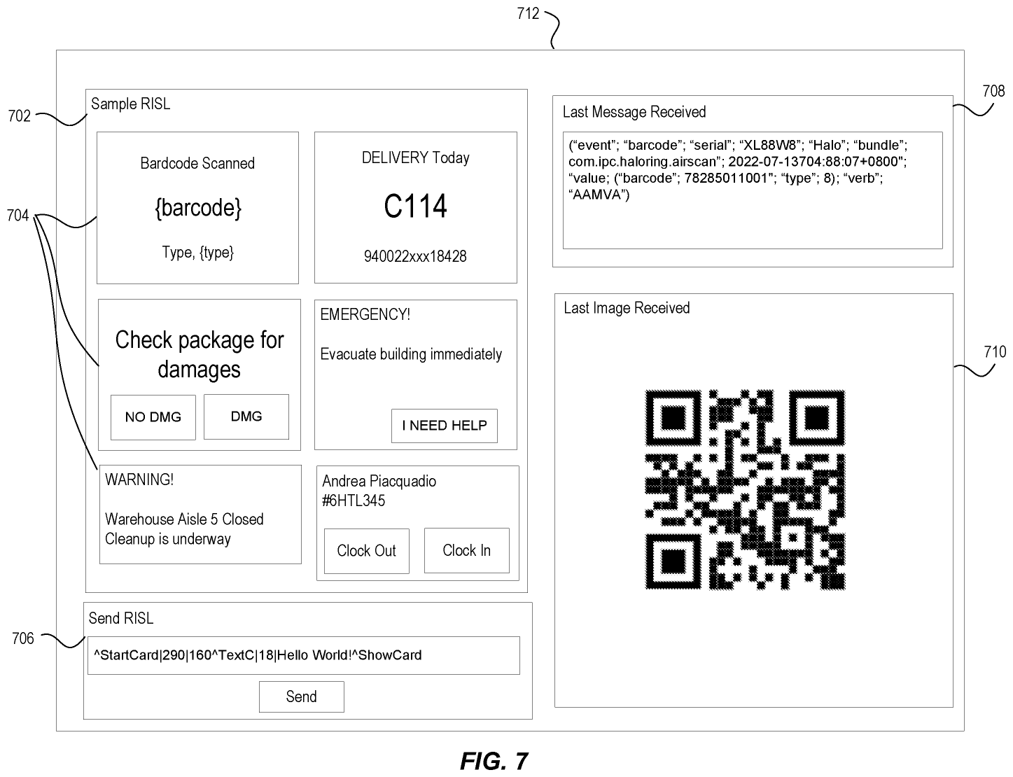

FIG. 7 shows a dashboard 712 that can be used by a programmer to interface with the ring scanner 112 via a remote system (remote servers, computers, etc.), according to aspects. In aspects, the dashboard 712 can be accessed via a web browser on the remote system. In aspects, the dashboard 712 can display information about the ring scanner 112 and can also be used to send RISL commands to the ring scanner (as shown in box 706). For example, the dashboard 712 can display different RISL cards that are stored on the ring scanner 112 (as shown by boxes 702 and 704), a last message received by the ring scanner 112 (as shown by box 708), a last image received by the ring scanner 112 (as shown in box 710), and a section where RISL commands can be sent to the ring scanner 112 (as shown in box 706).

In aspects, the connection between the ring scanner 112 and the remote system running the dashboard 712 can be over Wi-Fi via the Wi-Fi interface 424 or over Bluetooth via the Bluetooth interface 426.

In aspects, the dashboard can be accessed by inputting a uniform resource locator (URL) onto a web browser of the remote system. The URL can then take a user/programmer to a screen where the user/programmer can enter the identification number or name of a particular ring scanner 112 that he or she wants to view information about. In aspects, once the identification name or number is input, a dashboard like the one shown in FIG. 7 can populate the browser.

Dashboard 712 shows a box 702, which is an area that shows sample RISL cards that are stored on the specific ring scanner 112. Boxes 704 show the sample RISL cards on the particular ring scanner 112. In aspects, these RISL cards can be modified, added to, deleted using box 706, in which the user/programmer can send RISL commands to the ring scanner 112. In aspects, box 708 can show a last message received by the ring scanner 112. The last message received can be the result of a scan of a barcode, an image, and/or input received via a RISL card. In aspects, the dashboard 712 can also show the last image received by the ring scanner 112. Box 710 shows, the last image received as a barcode that was scanned. The last image can also be an image scanned by a camera of the ring scanner 112.

The disclosed RISL provides a unique programming language specific to ring scanners. RISL takes into account and is designed to accommodate the specialized form factor, display size, and functionality required of ring scanners. RISL provides a light weight language that is designed to take into account the memory constraints of a ring scanner 112. It does not require extensive memory to store the language. It is also designed so that it can be easily written by non-technical persons. The commands can be entered as strings in a text file, which can be loaded onto the ring scanner 112 and executed by one or more processors of the ring scanner 112 to generate the custom screens/cards. In this way, ring scanners can be easily programmed and modified without the need to know or have knowledge of traditional programming languages.

The above detailed description and aspects of the disclosed ring scanner 112 and RISL are not intended to be exhaustive or to limit the disclosed ring scanner 112 or RISL to the precise form disclosed above. While specific examples are described above for illustrative purposes, various equivalent modifications are possible within the scope of the disclosed ring scanner 112 and RISL, as those skilled in the relevant art will recognize. For example, while processes are presented in a given order, alternative implementations may perform routines having steps, or employ systems having processes or methods, in a different order, and some processes or methods may be deleted, moved, added, subdivided, combined, or modified to provide alternative or sub-combinations. Each of these processes or methods may be implemented in a variety of different ways. Also, while processes or methods are at times shown as being performed in series, these processes or blocks may instead be performed or implemented in parallel, or may be performed at different times.

The resulting process, apparatus, device, product, and ring scanner 112 is cost-effective, highly versatile, and accurate, and may be implemented by adapting components for ready, efficient, and economical manufacturing, application, and utilization. Another important aspect of the present disclosure is that it valuably supports and services the historic trend of reducing costs, simplifying systems, and increasing performance.

These and other valuable aspects of the present disclosure consequently further the state of the technology to at least the next level. While the disclosed aspects have been described as the best mode of implementing the ring scanner 112, it is to be understood that many alternatives, modifications, and variations will be apparent to those skilled in the art in light of the descriptions herein. Accordingly, it is intended to embrace all such alternatives, modifications, and variations that fall within the scope of the included claims. All matters set forth herein or shown in the accompanying drawings are to be interpreted in an illustrative and non-limiting sense.

What is claimed is:

1. A non-transitory computer readable medium of a ring scanner storing a programming language for controlling the ring scanner, wherein the programming language comprising:
one or more commands that are customized by a programmer of the ring scanner to enable the ring scanner to:
display custom screens on a display of the ring scanner based on an operating mode of the ring scanner, and
control the functionality of the ring scanner.

2. The non-transitory computer readable medium of claim 1, wherein the one or more commands enable customization of a screen width and a screen height of the custom screens.

3. The non-transitory computer readable medium of claim 1, wherein the one or more commands enable customization of a font of the custom screens.

4. The non-transitory computer readable medium of claim 1, wherein the one or more commands enable customization of a text of the custom screens.

5. The non-transitory computer readable medium of claim 1, wherein the one or more commands enable generating of custom icons for the custom screens.

6. The non-transitory computer readable medium of claim 1, wherein the one or more commands enable customization of a color of the custom screens.

7. The non-transitory computer readable medium of claim 1, wherein the one or more commands enable saving the custom screens to the non-transitory computer readable medium.

8. The non-transitory computer readable medium of claim 1, wherein the one or more commands enable loading the custom screens to the display of the ring scanner.

9. The non-transitory computer readable medium of claim 1, wherein the one or more commands enable searching for the custom screens.

10. The non-transitory computer readable medium of claim 1, wherein the one or more commands enable setting placeholders within a custom screen to add further custom information in place of the placeholder at a later time.

11. The non-transitory computer readable medium of claim 1, wherein the one or more commands enable a haptic output of the ring scanner.

12. The non-transitory computer readable medium of claim 1, wherein the one or more commands enable an audio output of the ring scanner.

13. The non-transitory computer readable medium of claim 1, wherein the one or more commands enable deletion of the custom screens.

14. The non-transitory computer readable medium of claim 1, wherein the one or more commands are invoked using the format:
[symbol] [command name] [delimiter] [parameters],
wherein,
[symbol] comprises a mark or character used as a conventional representation of an object, function, or process, and signals the beginning of a command of the one or more commands,
[command name] comprises a string indicating a name of the command of the one or more commands,
[delimiter] comprises a mark or character specifying a boundary between the [command name] and [parameters], and
[parameters] comprises an input value for defining an operation of the one or more commands.

15. The non-transitory computer readable medium of claim 14, wherein:
[symbol] is a circumflex accent represented by “\hat{ }”;
[delimeter] is a vertical line represented by “|”; and
[command name] is selected from at least one of: \hat{ }StartCard, \hat{ }Font, \hat{ }Text, \hat{ }TextC, \hat{ }TextL, \hat{ }TextR, \hat{ }Button, \hat{ }CardBackColor, AShowCard, ASaveCard, \hat{ }LoadCard, \hat{ }CardExists, \hat{ }Set, \hat{ }Vibrate, \hat{ }PlaySound, or \hat{ }Clear.

16. A ring scanner comprising:
a memory storing a programming language for operating the ring scanner; and
one or more processors, coupled to the memory, and configured to process one or more commands of the programming language to enable the ring scanner to:
display custom screens on a display of the ring scanner based on an operating mode of the ring scanner, and
control the functionality of the ring scanner.

17. The ring scanner of claim 16, wherein the one or more processors are further configured to process the one or more commands to:
enable customization of a screen width and a screen height of the custom screens.

18. The ring scanner of claim 16, wherein the one or more processors are further configured to process the one or more commands to:
enable customization of a font of the custom screens.

19. The ring scanner of claim 16, wherein the one or more processors are further configured to process the one or more commands to:
enable customization of a text of the custom screens.

20. The ring scanner of claim 16, wherein the one or more processors are further configured to process the one or more commands to:
enable generating of custom icons for the custom screens.

21. The ring scanner of claim 16, wherein the one or more processors are further configured to process the one or more commands to:
enable customization of a color of the custom screens.

22. The ring scanner of claim 16, wherein the one or more processors are further configured to process the one or more commands to:
enable saving the custom screens to the non-transitory computer readable medium.

23. The ring scanner of claim 16, wherein the one or more processors are further configured to process the one or more commands to:
enable loading the custom screens to the display of the ring scanner.

24. The ring scanner of claim 16, wherein the one or more processors are further configured to process the one or more commands to:
enable searching for the custom screens.

25. The ring scanner of claim 16, wherein the one or more processors are further configured to process the one or more commands to:
enable setting placeholders within a custom screen to add further custom information in place of the placeholder at a later time.

26. The ring scanner of claim 16, wherein the one or more processors are further configured to process the one or more commands to:
enable a haptic output of the ring scanner.

27. The ring scanner of claim 16, wherein the one or more processors are further configured to process the one or more commands to:
enable an audio output of the ring scanner.

28. The ring scanner of claim 16, wherein the one or more processors are further configured to process the one or more commands to:
enable deletion of the custom screens.

29. The ring scanner of claim 16, wherein the one or more commands are invoked using the format:
[symbol] [command name] [delimiter] [parameters],
wherein,
[symbol] comprises a mark or character used as a conventional representation of an object, function, or process,
[command name] comprises a string indicating a name of the one or more commands,
[delimiter] comprises a mark or character specifying a boundary between the [command name] and [parameters], and
[parameters] comprises an input value for defining an operation of the one or more commands.

30. The ring scanner of claim 29, wherein the one or more commands are invoked using the format:
[symbol] is a circumflex accent represented by “\hat{ }”;
[delimeter] is a vertical line represented by “1”; and
[command name] is selected from at least one of: \hat{ }StartCard, \hat{ }Font, \hat{ }Text, \hat{ }TextC, \hat{ }TextL, \hat{ }TextR, \hat{ }Button, \hat{ }CardBackColor, AShowCard, ASaveCard, \hat{ }LoadCard, \hat{ }CardExists, \hat{ }Set, \hat{ }Vibrate, \hat{ }PlaySound, or \hat{ }Clear.
